(19) United States
(12) Patent Application Publication
(10) Pub. No.: US 2026/0091699 A1
(43) Pub. Date: Apr. 2, 2026

(54) METHOD OF MULTI-CONTACT CHARGING AND DISCHARGING FOR ELECTRIC VEHICLES

(71) Applicant: Volvo Car Corporation, Göteborg (SE)

(72) Inventors: Andreas ROPEL, Torslanda (SE); Jones SCHÖLD, Göteborg (SE); Fredrik HAAK, Ödsmål (SE); Ali FOTOUHI, Kungsbacka (SE); Virat ANDODARIYA, Göteborg (SE); Vijay ARUMUGAM, Göteborg (SE)

(73) Assignee: Volvo Car Corporation, Göteborg (SE)

(21) Appl. No.: 18/899,654

(22) Filed: Sep. 27, 2024

(51) Int. Cl. B60L 53/30; B60L 53/18; B60L 53/62

(52) U.S. Cl. CPC B60L 53/305; B60L 53/18; B60L 53/62

(57) ABSTRACT

A system is described. The system comprises: a battery pack that comprises one or more portions; one or more contact points for connecting a charging cable to the battery pack; and a processor communicatively coupled to the battery pack, wherein the processor is operable to: receive a user preference that comprises a first charging level and a first discharging level from a user; perform at least one of charging and discharging one or more first portions among one or more portions based on the user preference; monitor one or more battery parameters of the one or more first portions in real time; and communicate a message that comprises a recommendation of at least one of a second charging level and a second discharging level for the one or more first portions to perform at least one of charging and discharging based on the one or more battery parameters.

### FIELD OF THE INVENTION

The present disclosure relates generally to electric vehicle (EV) charging systems. More specifically, the present disclosure relates to a system and method of multi-contact charging and discharging based on user preferences and real-time battery parameters.

### BACKGROUND

Electric vehicles (EVs) typically use one or two pre-designated connection points for charging, limiting flexibility and efficiency. Fast charging through these limited connections can lead to significant heat buildup, posing safety risks and reducing the system's efficiency. The rigidity of current systems, with each connection assigned to a specific charging type, fails to adapt to varying user needs and battery conditions, resulting in suboptimal charging performance.

Therefore, there is a long-felt need for a system and method of multi-contact charging and discharging based on user preferences and real-time battery parameters.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented that facilitate multi-contact charging and discharging based on user preferences and real-time battery parameters.

In an aspect, a system is described. The system comprises: a battery pack that comprises one or more portions, wherein each of the one or more portions is cond to support one or more charging levels and one or more discharging levels; one or more contact (connection) points for connecting a charging cable to the battery pack, wherein each of the one or more contact points are assigned to one of the one or more charging levels and the one or more discharging levels; and a processor communicatively coupled to the battery pack, wherein the processor is operable to: receive a user preference that comprises a first charging level and a first discharging level from a user; perform at least one of charging and discharging one or more first portions among the one or more portions of the battery pack based on the user preference; monitor one or more battery parameters of the one or more first portions of the battery pack in real time; and communicate a message that comprises a recommendation of at least one of a second charging level and a second discharging level for the one or more first portions to perform at least one of charging and discharging based on the one or more battery parameters.

In one aspect, a method is described. The method comprises: receiving a user preference that comprises a first charging level and a first discharging level from a user; performing at least one of charging and discharging one or more first portions among one or more portions of a battery pack based on the user preference, wherein each of the one or more portions is configured to support one or more charging levels and one or more discharging levels; monitoring one or more battery parameters of the one or more first portions of the battery pack in real time; and communicating a message that comprises a recommendation of at least one of a second charging level and a second discharging level for the one or more first portions to perform at least one of charging and discharging based on the one or more battery parameters.

In one aspect, a non-transitory computer readable storage medium is described. The non-transitory computer readable storage medium comprising a sequence of instructions, which when executed by a processor causes: receiving a user preference that comprises a first charging level and a first discharging level from a user; performing at least one of charging and discharging one or more first portions among one or more portions of a battery pack based on the user preference, wherein each of the one or more portions is configured to support one or more charging levels and one or more discharging levels; monitoring one or more battery parameters of the one or more first portions of the battery pack in real time; and communicating a message that comprises a recommendation of at least one of a second charging level and a second discharging level for the one or more first portions to perform at least one of charging and discharging based on the one or more battery parameters.

In one aspect, a system is described. The system comprises: a battery pack that comprises one or more portions, wherein each of the one or more portions is configured to support one or more charging levels and one or more discharging levels; one or more contact points for connecting a charging cable to the battery pack, wherein each of the one or more contact points are assigned to one of the one or more charging levels and the one or more discharging levels; a processor communicatively coupled to the battery pack, wherein the processor is operable to: receive a user preference that comprises a first charging level and a first discharging level from a user; perform at least one of charging and discharging the one or more first portions of the battery pack based on the user preference; monitor one or more battery parameters of the one or more first portions of the battery pack in real time; and communicate a message that comprises a recommendation of one or more second portions among the one or more portions to perform at least one of charging and discharging based on the one or more battery parameters.

In one aspect, a method is described. The method comprises: receiving a user preference that comprises a first charging level and a first discharging level from a user; performing at least one of charging and discharging one or more first portions of a battery pack based on the user preference, wherein each of the one or more portions is configured to support one or more charging levels and one or more discharging levels; monitoring one or more battery parameters of the one or more first portions of the battery pack in real time; and communicating a message that comprises a recommendation of one or more second portions among the one or more portions to perform at least one of charging and discharging based on the one or more battery parameters.

In one aspect, a non-transitory computer readable storage medium is described. The non-transitory computer readable storage medium comprising a sequence of instructions which, when executed by a processor, causes: receiving a user preference that comprises a first charging level and a first discharging level from a user; performing at least one of charging and discharging one or more first portions of a battery pack based on the user preference, wherein each of the one or more portions is configured to support one or more charging levels and one or more discharging levels; monitoring one or more battery parameters of the one or more first portions of the battery pack in real time; and communicating a message that comprises a recommendation of one or more second portions among the one or more portions to perform at least one of charging and discharging based on the one or more battery parameters.

In an aspect, a vehicle is described. The vehicle comprises: a battery pack that comprises one or more portions, wherein each of the one or more portions is configured to support one or more charging levels and one or more discharging levels; one or more contact points for connecting a charging cable to the battery pack, wherein each of the one or more contact points are assigned to one of the one or more charging levels and the one or more discharging levels; and a processor communicatively coupled to the battery pack, wherein the processor is operable to: receive a user preference that comprises a first charging level and a first discharging level from a user; perform at least one of charging and discharging one or more first portions among the one or more portions of the battery pack based on the user preference; monitor one or more battery parameters of the one or more first portions of the battery pack in real time; and communicate a message that comprises a recommendation of at least one of a second charging level and a second discharging level for the one or more first portions to perform at least one of charging and discharging based on the one or more battery parameters.

In one aspect, a vehicle is described. The vehicle comprises: a battery pack that comprises one or more portions, wherein each of the one or more portions is configured to support one or more charging levels and one or more discharging levels; one or more contact points for connecting a charging cable to the battery pack, wherein each of the one or more contact points are assigned to one of the one or more charging levels and the one or more discharging levels; a processor communicatively coupled to the battery pack, wherein the processor is operable to: receive a user preference that comprises a first charging level and a first discharging level from a user; perform at least one of charging and discharging the one or more first portions of the battery pack based on the user preference; monitor one or more battery parameters of the one or more first portions of the battery pack in real time; and communicate a message that comprises a recommendation of one or more second portions among the one or more portions to perform at least one of charging and discharging based on the one or more battery parameters.

In one aspect, a vehicle energy management system is described. The vehicle energy management system comprises: multiple contact points for a charging cable to connect; an energy routing system configured to route energy to specific sections of a battery, wherein the battery is divided into multiple sections designated for different charge rates; adaptively adjusts the charge rate based on health of the battery by monitoring temperature of each section; and reroute the energy if a section exceeds a predetermined temperature threshold.

The methods and systems disclosed herein may be implemented in any means for achieving various aspects and may be executed in a form of a non-transitory machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE FIGURES

These and other aspects of the present disclosure will now be described in more detail, with reference to the appended drawings showing exemplary embodiments, in which:

FIG. 1 illustrates a system for recommending one or more charging levels and one or more discharging levels according to one or more embodiments.

FIG. 2 illustrates a method for recommending one or more charging levels and one or more discharging levels, according to one or more embodiments.

FIG. 3 illustrates a non-transitory computer readable storage medium block diagram for recommending one or more charging levels and one or more discharging levels, according to one or more embodiments.

FIG. 4 illustrates a system for recommending one or more portions, according to one or more embodiments.

FIG. 5 illustrates a method for recommending one or more portions, according to one or more embodiments.

FIG. 6 illustrates a non-transitory computer readable storage medium block diagram for recommending one or more portions, according to one or more embodiments.

FIG. 7 illustrates a battery pack comprising an individual battery, according to one or more embodiments.

FIG. 8 illustrates a battery pack comprising a plurality of batteries, according to one or more embodiments.

FIG. 9 schematically shows a battery pack comprising a battery and a battery management system, according to one or more embodiments.

FIG. 10 illustrates a system integrated into a vehicle according to one or more embodiments.

FIG. 11 illustrates a schematic view of a system that comprises a battery pack and one or more contact points according to one or more embodiments.

FIG. 12 illustrates a charging message received from a system, according to one or more embodiments.

FIG. 13 illustrates a discharging message received from a system, according to one or more embodiments.

FIG. 14 illustrates a charging message received from a system, according to one or more embodiments.

FIG. 15 illustrates a discharging message received from a system, according to one or more embodiments.

FIG. 16 illustrates a communication flow between a system and a user according to one or more embodiments.

FIG. 17A shows a structure of the neural network / machine learning model with a feedback loop.

FIG. 17B shows a structure of the neural network / machine learning model with reinforcement learning.

FIG. 18A shows a block diagram of the cyber security module in view of the system and server.

FIG. 18B shows an embodiment of the cyber security module.

FIG. 18C shows another embodiment of the cyber security module.

Other features of the present embodiments will be apparent from the accompanying drawings and from the detailed description that follows.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

Unless defined otherwise, all technical and scientific terms used herein have the same meaning as commonly understood by one with ordinary skill in the art.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having,” or the like are open-ended terms. Further, the phrase “based on” means “based, at least in part, on”unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc., in question is or is not removable.

As used herein, the term “or” means an inclusive “or” rather than an exclusive “or.” That is, unless specified otherwise, or clear from context. “X employs A or B” means any of the natural inclusive permutations. That is, if X employs A; X employs B; or X employs both A and B, then “X employs A or B”is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately”can mean within plus or minus one percent of the stated value.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc., may embed a computer. Computer readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Embodiments may comprise or utilize a special purpose or general purpose computer including computer hardware. Embodiments within the scope of the present invention may also include physical and other computer readable media for carrying or storing computer-executable instructions and/or data structures. Such computer readable media can be any media accessible by a general purpose or special purpose computer system. Computer readable media that store computer-executable instructions are physical storage media. Computer readable media that carry computer-executable instructions are transmission media. Thus, by way of example and not limitation, embodiments of the invention can comprise at least two distinct kinds of computer readable media: physical computer readable storage media and transmission computer readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer readable media includes combinations of the above, that enable the transport of electronic data between computer systems and/or modules and/or other electronic devices. Further, upon reaching various computer system components, program code in the form of computer-executable instructions or data structures can be transferred automatically from transmission computer readable media to physical computer readable storage media (or vice versa). For example, computer-executable instructions or data structures received over a network or data link can be buffered in RAM within a Network Interface Controller (NIC), and then eventually transferred to computer system RAM and/or to less volatile computer readable physical storage media at a computer system. Thus, computer system components that also (or even primarily) utilize transmission media may include computer readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

The following terms and phrases, unless otherwise indicated, shall have the following meanings.

As used herein, the term “electric vehicle (EV)” refers to an automobile, as defined in 49 Code of Federal Regulations (CFR) 523.3, intended for highway use, powered by an electric motor that draws current from an on-vehicle energy storage device, such as a battery, which is rechargeable from an off-vehicle source, such as residential or public electric service or an on-vehicle fuel powered generator. The EV may be two or more wheeled vehicles manufactured for use primarily on public streets, roads. The EV may be referred to as an electric car, an electric automobile, an electric road vehicle (ERV), a plug-in vehicle (PV), a plug-in vehicle (xEV), etc., and the xEV may be classified into a plug-in all-electric vehicle (BEV), a battery electric vehicle, a plug-in electric vehicle (PEV), a hybrid electric vehicle (HEV), a hybrid plug-in electric vehicle (HPEV), a plug-in hybrid electric vehicle (PHEV), etc.

As used herein, the term “plug-in electric vehicle (PEV)” refers to an Electric Vehicle that recharges the on-vehicle primary battery by connecting to the power grid.

As used herein, the term “plug-in vehicle (PV)” refers to an electric vehicle rechargeable through wireless charging from an electric vehicle supply equipment (EVSE) without using a physical plug or a physical socket.

As used herein, the term “heavy duty vehicle (HD Vehicle)” refers to any four-or-more wheeled vehicle as defined in 49 CFR 523.6 or 49 CFR 37.3 (bus).

As used herein, the term “light duty plug-in electric vehicle” refers to a three or four-wheeled vehicle propelled by an electric motor drawing current from a rechargeable storage battery or other energy devices for use primarily on public streets, roads and highways and rated at less than 4,545 kg, (10,000 lbs.) gross vehicle weight.

As used herein, the term “battery pack” as used herein refers to a set of any number of identical batteries or individual cells of a battery. The “battery pack” may also refer to a set of non-identical batteries. The batteries in the battery pack may be configured in a series, parallel or a mixture of both to deliver the desired voltage, capacity, and/or power density.

As used herein, the term “user preference” refers to the specific choices or settings selected by a user regarding the operation of a system. In the context of battery management systems, this includes the desired charging and discharging levels or types that the user wishes to apply to the battery pack or its portions.

As used herein, the term “assign” refers to the process of allocating or designating a specific function, role, or attribute to a particular entity or component. In the context of battery management systems, this involves specifying or setting a particular charging or discharging level for a battery pack or a portion of the battery pack based on predefined criteria or user input.

As used herein, the term “one or more portions” refers to distinct sections or segments within a battery pack. These portions can function independently or in coordination with each other to manage and distribute the electrical energy stored within the battery pack. Each portion can be configured to support specific charging and discharging processes, optimizing the overall performance and efficiency of the battery pack.

As used herein, the term “one or more charging levels” refers to the various methods and rates at which a battery can be charged. Each level of charging is defined by the speed and amount of energy delivered to the battery, enabling different charging strategies to optimize performance, safety, and battery longevity. These levels comprise fast charging, standard charging, trickle charging, level 1 charging, level 2 charging, and level 3 charging.

As used herein, the term “one or more contact points” refers to the various locations or interfaces where a charging cable or connector can physically connect to a battery or energy system. Each contact point facilitates the transfer of electrical energy between the external charging source and the battery, enabling different charging and discharging processes.

As used herein, the term “charging cable” refers to a flexible electrical conductor used to transfer electrical energy from a power source to a battery or energy storage system. The charging cable typically consists of insulated wires that carry electrical current and connectors at both ends to facilitate secure and reliable connections. The cable enables the transfer of energy for various types of charging processes, such as fast charging or standard charging, depending on the design and specifications of the cable and the charging system.

As used herein, the term “charging” refers to the process of supplying electrical energy to a battery or energy storage device to restore its stored energy. During charging, electrical current flows into the battery, converting electrical energy into chemical energy stored within the battery cells.

As used herein, the term “discharging” refers to the process of releasing electrical energy from a battery or energy storage device to power electrical devices or systems. While discharging, the chemical energy stored in the battery is converted back into electrical energy that flows out of the battery to perform work.

As used herein, the term “one or more positions” refers to various locations or areas within or around the vehicle where components, such as charging connectors or sensors, are installed or utilized. Each position is strategically chosen to facilitate specific functions, such as charging, discharging, or monitoring, and can include locations like the front, rear, or sides of the vehicle.

As used herein, the term “one or more first portions” refers to specific portions or segments of a battery pack that are designated or selected for a particular charging or discharging operation. These portions can be independently managed to handle specific charging or discharging tasks based on operational needs or user preferences.

As used herein, the term “one or more second portions” refers to additional or alternative portions or segments of a battery pack, other than the first portions, that may be selected or utilized for different charging or discharging operations. These portions provide flexibility in energy management and distribution within the battery pack.

As used herein, the term “first charging level” refers to a charging method characterized by high-speed energy transfer to the battery.

As used herein, the term “second charging level” refers to a charging method that provides a moderate speed of energy transfer to the battery.

As used herein, the term “third charging level” refers to a charging method that delivers energy to the battery at a slow rate.

As used herein, the term “fast charging” refers to a method of charging a battery at a higher rate than standard charging, allowing for a quicker replenishment of the battery's energy. This type of charging typically uses higher voltage and current levels to significantly reduce the time required to charge a battery to a specific level.

As used herein, the term “standard charging” refers to the conventional method of charging a battery at a moderate and consistent rate. Standard charging uses typical voltage and current levels recommended by the battery manufacturer to ensure safe and efficient charging without excessively stressing the battery cells.

As used herein, the term “trickle charging” refers to a method of charging a battery at a very low rate, typically just enough to compensate for the self-discharge of the battery. Trickle charging is used to maintain a fully charged battery over an extended period without overcharging or damaging the battery cells.

As used herein, the term “one or more discharging levels” refers to the various methods and rates at which a battery releases its stored energy. Each discharging level is defined by the speed and amount of energy extracted from the battery, enabling different discharging strategies to optimize performance, safety, and battery longevity. These levels comprise rapid discharging, standard discharging, slow discharging, high-power discharging, continuous discharging, and pulse discharging.

As used herein, the term “first discharging level” refers to a discharging method characterized by high power output from the battery.

As used herein, the term “second discharging level” refers to a discharging method that provides a moderate power output from the battery.

As used herein, the term “third discharging level” refers to a discharging method characterized by low power output from the battery.

As used herein, the term “high power discharging” refers to a discharging method in which the battery releases a substantial amount of energy rapidly. This type of discharging method is typically employed when a high-power output is required, such as for rapid acceleration or powering high-energy devices.

As used herein, the term “standard discharging” refers to a discharging method in which the battery provides a moderate level of energy output. This type of discharging method is used for typical operational conditions where a balanced power supply is needed for regular use.

As used herein, the term “low power discharging” refers to a discharging method where the battery releases energy at a slow and steady rate. This type of discharging method is typically used for applications that require minimal energy consumption, such as for maintaining battery charge during idle periods or for low-power devices.

As used herein, the term “one or more battery parameters” refers to the numerical values that describe a battery's nominal and maximum characteristics, such as its voltage, capacity, energy density, power density, internal resistance, state of charge, depth of discharge, cycle life, self-discharge rate, and round-trip efficiency.

As used herein, the term “state-of-charge (SoC)” refers to the level of charge of an electric battery pack relative to its capacity. The units of SoC are percentage points (0%=empty; 100%=full). An alternative form of the same measure is the depth of discharge (DoD), the inverse of SoC (100%=empty; 0%=full). SoC is normally used when discussing the current state of a battery in use, while DoD is most often seen when discussing the lifetime of the battery after repeated use.

As used herein, the term “state-of-health (SoH)” refers to a figure of merit of the condition of a battery pack, compared to its ideal conditions. The state-of-health (SoH) of a battery pack describes the difference between a battery pack being studied and a fresh battery pack and considers cell aging. The SoH is defined as the ratio of the maximum battery charge to its rated capacity. It may be expressed in percentage form. The battery pack may comprise one or more batteries.

As used herein, the term “voltage” refers to the electrical potential difference across the battery terminals, typically measured in volts (V).

As used herein, the term “current” refers to the rate at which electrical charge is flowing into or out of the battery. Positive current indicates that the battery is being charged, while negative current indicates that the battery is being discharged.

As used herein, the term “temperature” refers to the operating temperature of the battery. Monitoring the temperature is crucial as it affects the battery's performance, safety, and longevity. Excessive temperatures can lead to battery degradation or safety hazards.

As used herein, the term “capacity” refers to the total amount of energy the battery can store, typically measured in ampere-hours (Ah) or watt-hours (Wh). It represents the battery's ability to hold charge and decreases over time due to wear and tear.

As used herein, the term “internal resistance” refers to the resistance within the battery that affects its ability to deliver current. Higher internal resistance usually indicates aging or damage and can impact the battery's efficiency and performance.

As used herein, the term “cycle count” refers to the number of complete charge and discharge cycles the battery has undergone. This parameter is an indicator of the battery's lifespan, with each cycle contributing to gradual capacity loss.

As used herein, the term “charge rate” refers to the rate at which a battery is charged, typically measured in amps (A). The charge rate indicates how quickly the battery can be replenished.

As used herein, the term “discharge rate” refers to the rate at which a battery discharges its stored energy, also measured in amps (A). The discharge rate reflects how quickly the battery can supply power to a load.

As used herein, the term “C-rate” refers to the speed at which the battery is charged or discharged, typically expressed as a multiple of its capacity. For example, a 1C rate means charging or discharging at a rate equal to the battery's capacity.

As used herein, the term “energy density” refers to the amount of energy stored in a given volume or mass of the battery, often measured in watt-hours per kilogram (Wh/kg) or watt-hours per liter (Wh/L). Energy density indicates the efficiency of the battery in storing energy relative to its size or weight.

As used herein, the term “power density” refers to the amount of power a battery can deliver per unit volume or mass.

As used herein, the term “Depth of Discharge (DoD)” refers to the percentage of the battery's total capacity that has been used or discharged. It is the inverse of State-of-Charge (SoC) and is a key factor in determining the lifespan and performance of the battery. For example, a DoD of 60% means 60% of the battery's capacity has been discharged.

As used herein, the term “charge acceptance” refers to the ability of the battery to accept charge, especially at high charging rates. It indicates how efficiently the battery can be recharged and is influenced by factors like temperature and State-of-Health (SoH).

As used herein, the term “round-trip efficiency” refers to the ratio of the energy delivered by the battery during discharge to the energy stored during charging. It is expressed as a percentage and indicates how effectively a battery converts and stores energy. Higher discharge efficiency indicates less energy loss during the discharge process.

As used herein, the term “self-discharge rate” refers to the rate at which a battery loses its charge while not in use. This parameter varies with temperature and battery chemistry and affects the battery's shelf life and readiness. Self-discharge is typically measured as a percentage of capacity lost per month.

As used herein, the term “maximum charge/discharge current” refers to the highest current that can safely be applied to or drawn from the battery. Exceeding this limit can lead to overheating, damage, or safety issues.

As used herein, the term “thermal stability” refers to a battery's ability to maintain its performance and safety under varying temperature conditions. The thermal stability indicates how well the battery can operate and remain safe within a specified temperature range without significant degradation or risk of failure.

As used herein, the term “thermal runaway threshold” refers to the temperature point beyond which a battery may enter an uncontrollable exothermic reaction, leading to overheating, potential fire, or explosion.

As used herein, the term “voltage sag” refers to the drop in voltage experienced when a high current is drawn from the battery. The voltage sag: indicates the battery's ability to maintain voltage under load, and affects performance in high-power applications.

As used herein, the term “charge cut-off voltage” refers to the maximum voltage to which a battery is charged to ensure safety and longevity.

As used herein, the term “discharge cut-off voltage” refers to the minimum voltage to which a battery is discharged to prevent over-discharge.

As used herein, the term “impedance” refers to the total opposition to current flow within the battery, including both resistance and reactance.

As used herein, the term “calendar life” refers to the expected lifespan of the battery regardless of the number of charge/discharge cycles, typically influenced by storage conditions and battery chemistry.

As used herein, the term “float voltage” refers to the voltage at which a fully charged battery is maintained to keep it at full charge without overcharging. It is used in applications where the battery is continuously connected to a charger.

As used herein, the term “Peukert's number” refers to a constant that characterizes the effect of discharge rate on the battery's capacity. Higher Peukert's numbers indicate greater capacity loss at higher discharge rates.

As used herein, the term “threshold level” refers to a predefined limit or boundary value used to evaluate certain conditions or parameters. In the context of battery management, the threshold level is often used to monitor and control the performance of the battery. It represents the maximum or minimum acceptable value for metrics such as temperature, voltage, or current flow. When these metrics exceed or fall below the threshold level, it triggers specific actions or responses, such as adjusting charging rates, activating cooling systems, or initiating safety protocols to maintain optimal battery performance and prevent damage.

As used herein, the term “message” refers to any form of communication transmitted to the user, typically in the form of a notification, alert, or prompt. This communication includes detailed information about the current status, recommendations, and necessary actions related to the system's operation. The message can be conveyed through various interfaces, such as an interactive display on a wall unit, a user device, or other communication platforms associated with the system.

As used herein, the term “recommendation” refers to a suggestion or advice generated by the system's processor based on real-time data and analysis. This recommendation is aimed at optimizing the performance and safety of the system, and it typically includes advice on selecting appropriate charging or discharging levels, adjusting operational parameters, or taking specific actions to address identified issues.

As used herein, the term “infotainment system” or “infotainment unit” or “in-vehicle infotainment system” (IVI) as used herein refers to a combination of systems which are used to deliver entertainment and information. In an example, the information may be delivered to the driver and the passengers of a vehicle through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

The term “vehicle” as used herein refers to a thing used for transporting people or goods. Automobiles, cars, trucks, buses, etc., are examples of vehicles.

As used herein, the term “vehicle computer system” refers to a system in automotive electronics that controls one or more of the electrical systems or subsystems in a vehicle. The computer executes a large number of different software functions in the powertrain, chassis, driver assistance, and infotainment domains, etc., that are executed on separate control units. The vehicle computer system may be communicatively coupled with an external device of a user.

As used herein, the term “interactive display” refers to a user interface embedded in or mounted on a wall-mounted unit that allows users to interact with and control various functions or settings related to a system.

As used herein, the term “user device” refers to any electronic or digital equipment used by an individual to interact with or control a system. The user device can be a smartphone, tablet, laptop or desktop computer and smartwatch.

As used herein, the term “communication” refers to the transmission of information and/or data from one point to another. Communication may be by means of electromagnetic waves. It is also a flow of information from one point, known as the source, to another, the receiver. Communication comprises one of the following: transmitting data, instructions, and information or a combination of data, instructions, and information. Communication happens between any two communication systems or communicating units. The term “in communication with” may refer to any coupling, connection, or interaction using electrical signals to exchange information or data, using any system, hardware, software, protocol, or format, regardless of whether the exchange occurs wirelessly or over a wired connection. The term “communication” includes systems that combine other more specific types of communication, such as V2I (Vehicle-to-Infrastructure), V2I (Vehicle-to-Infrastructure), V2N (Vehicle-to-Network), V2V (Vehicle-to-Vehicle), V2P (Vehicle-to-Pedestrian), V2D (Vehicle-to-Device) and V2G (Vehicle-to-Grid) and Vehicle-to-Everything (V2X) communication. V2X communication is the transmission of information from a vehicle to any entity that may affect the vehicle, and vice versa. The main motivations for developing V2X are occupant safety, road safety, traffic efficiency and energy efficiency. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.). Further, the emergency communication apparatus is configured on a computer with the communication function and is connected for bidirectional communication with the on-vehicle emergency report apparatus by a communication line through a radio station and a communication network such as a public telephone network or by satellite communication through a communication satellite. The emergency communication apparatus is adapted to communicate, through the communication network, with communication terminals including a road management office, a police station, a fire department, and a hospital. The emergency communication apparatus can also be connected online with the communication terminals of the persons or vehicles concerned, associated with the occupant or vehicle, and the driver or vehicle receiving the service of the emergency-reporting vehicle.

The terms “non-transitory computer readable medium” and “computer readable medium” include a single medium or multiple media such as a centralized or distributed database, and/or associated caches and servers that store one or more sets of instructions. Further, the terms “non-transitory computer readable medium” and “computer readable medium” include any tangible medium that is capable of storing, encoding, or carrying a set of instructions for execution by a processor that, for example, when executed, cause a system to perform any one or more of the methods or operations disclosed herein. As used herein, the term “computer readable medium” is expressly defined to include any type of computer readable storage device and/or storage disk and to exclude propagating signals.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in an RS-232 serial transmission. A software handshake sends codes such as “synchronize” (SYN) and “acknowledge” (ACK) in a TCP/IP transmission.

The term “in communication with” as used herein, refers to any coupling, connection, or interaction using electrical signals to exchange information or data, using any system, hardware, software, protocol, or format, regardless of whether the exchange occurs wirelessly or over a wired connection.

As used herein, the term “network” may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. For example, the computer readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, does not construe transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein are downloadable to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, stand-alone computers can practice one or more, if not all, aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multi-thread execution capability; multi-core processors; multi-core processors with software multi-thread execution capability; multi-core processors with hardware multi-thread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising”as “comprising”is interpreted when employed as a transitional word in a claim.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

Business problem: Current EV charging systems use one or two fixed connection points for charging, which limits their flexibility and efficiency. Prolonged charging through these limited connections, especially during fast charging, causes significant heat buildup, posing safety risks and potential harm to users. This increases liability and warranty claims for manufacturers and leads to inefficient charging processes. The inability to adapt charging types based on real-time user needs and battery conditions results in suboptimal charging performance and longer charging times. This reduces user satisfaction and increases operational costs for EV manufacturers and operators.

Business solution: The present system addresses the limitations of existing EV charging setups by providing a more adaptable and efficient multi-contact charging solution. The present system enables multiple charging connections, each capable of handling different types of charges. This flexibility enables the system to distribute charging loads more evenly, reducing heat buildup and improving safety. By allowing dynamic assignment of charging types to each connection based on real-time user needs and battery conditions, the system enhances charging efficiency and performance. This solution minimizes operational costs and warranty claims, improves user satisfaction, and optimizes the overall charging process for EV manufacturers and operators.

Technical problem: Current electric vehicle (EV) charging systems rely on one or two fixed connection points that are pre-designated for specific types of charging, such as fast or standard charging. This design limits flexibility and efficiency, leading to significant heat buildup during prolonged charging sessions, especially with fast charging. The rigid assignment of connection types restricts the ability to adapt to varying user needs and battery conditions, resulting in suboptimal charging performance, increased safety risks, and longer charging times. This rigidity also contributes to higher operational costs and potential warranty claims due to the lack of adaptability in the charging process.

Technical Solution: The present system includes multiple connection/contact points, each capable of handling different types of charging and discharging, such as fast, standard, or trickle charging. The present system dynamically adapts the function of each connection point based on real-time user selections and battery conditions. The present system optimizes energy routing to different portions of the battery, reduces heat buildup by distributing the charging load, and improves overall safety. The present system also enables adaptive designation of connections, allowing for efficient and customizable charging based on immediate needs.

Technical Result: The present system enhances the flexibility and efficiency of EV charging processes. By allowing each connection point to handle different types of charging and adapt dynamically to user preferences and battery conditions, the present system minimizes heat buildup and improves safety. The ability to route energy effectively across various battery portions leads to more efficient charging, reduced charging times, and lower operational costs. Users will benefit from a more reliable and versatile charging experience, while manufacturers will see a reduction in warranty claims and increased customer satisfaction.

### Technical Details Specific to Technical Result

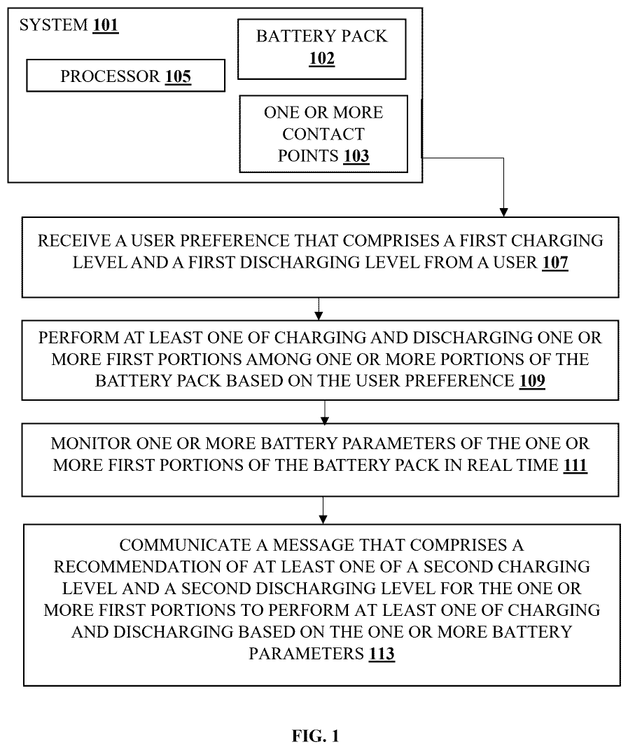

In an aspect, a system is described. As an example, FIG. 1 illustrates a system 101 for recommending one or more charging and one or more discharging levels, according to one or more embodiments. The system 101 comprises: a battery pack 102 that comprises one or more portions, wherein each of the one or more portions is configured to support one or more charging levels and one or more discharging levels; one or more contact points 103 for connecting a charging cable to the battery pack 102, wherein each of the one or more contact points 103 are assigned to one of the one or more charging levels and the one or more discharging levels; a processor 105 communicatively coupled to the battery pack 102, wherein the processor 105 is operable to: receive a user preference that comprises a first charging level and a first discharging level from a user (at step 107); perform at least one of charging and discharging one or more first portions among the one or more portions of the battery pack 102 based on the user preference (at step 109); monitor one or more battery parameters of the one or more first portions of the battery pack 102 in real time (at step 111); and assign at least one of a second charging level and a second discharging level for the one or more first portions to perform at least one of charging and discharging based on the one or more battery parameters (at step 113).

In one embodiment, each portion of the one or more portions is connected electrically. In one embodiment, the each portion is connected with the one or more contact points 103.

In one embodiment, the system 101 is integrated into a vehicle. In one embodiment, the one or more contact points 103 are electrically coupled at one or more positions of the vehicle. In one embodiment, the one or more positions are selected from the group consisting of front, rear, and left and right side of the vehicle.

In one embodiment, the one or more charging levels comprise at least one of the first charging level, the second charging level and a third charging level. In one embodiment, the first charging level is fast charging. In one embodiment, the second charging level is standard charging. In one embodiment, the third charging level is trickle charging.

In one embodiment, the one or more discharging levels comprise at least one of the first discharging level, the second discharging level and a third discharging level. In one embodiment, the first discharging level is high power discharging. In one embodiment, the second discharging level is standard discharging. In one embodiment, the third discharging level is low power discharging.

In one embodiment, the one or more battery parameters comprise at least one of temperature, voltage, current flow, state of charge (SOC), state of health (SOH), internal resistance, cycle count, capacity, power output, charge rate, discharge rate, energy density, Depth of Discharge (DoD), and C-rate.

In one embodiment, the processor 105 is operable to assign at least one of the second charging level and the second discharging level for the one or more first portions based on the user preference.

In one embodiment, the processor 105 is operable to continuously monitor the one or more battery parameters of the one or more first portions to determine if the one or more battery parameters exceed a threshold level. In one embodiment, the processor 105 is operable to modify one of the first charging level and the first discharging level assigned to the one or more first portions if the one or more battery parameters of the one or more first portions exceed the threshold level.

In one embodiment, the processor 105 is operable to modify one of the first charging level and the first discharging level assigned to the one or more first portions based on the user preference In one embodiment, the processor 105 is operable to perform at least one of charging and discharging the one or more first portions of the battery pack 102 based on the second charging level and the second discharging level until the one or more battery parameters of the one or more first portions reach a threshold level.

In one embodiment, the processor 105 is operable to reassign the first charging level and the first discharging level to the one or more first portions if the one or more battery parameters of the one or more first portions fall below the threshold level. In one embodiment, the processor 105 is operable to reassign the first charging level and the first discharging level to the one or more first portions based on the user preference.

In one embodiment, the processor 105 is operable to modify the one or more charging levels assigned to the one or more contact points 103 based on the user preference. In one embodiment, the processor 105 is operable to modify the one or more discharging levels assigned to the one or more contact points 103 based on the user preference.

In one embodiment, the processor 105 is operable to receive the user preference through an interactive display within the vehicle. In one embodiment, the processor 105 is operable to receive the user preference through a user device associated with the user. In one embodiment, the processor 105 is operable to receive the user preference from the user device through a network. In one embodiment, the network comprises a communication network selected from a group comprising wired networks, wireless networks, and a combination thereof. In one embodiment, the processor 105 is operable to receive the user preference through an interactive display on a wall unit (e.g., in a garage).

How Technical Solution is a Technological Advancement: The technical solution introduces a flexible and adaptive multi-contact charging system for electric vehicles (EVs). Unlike conventional systems with fixed connection points, this solution allows each contact point to handle various charging types dynamically. This adaptability improves energy management by efficiently routing energy to different battery portions based on real-time needs, reducing heat buildup and enhancing safety. The system's ability to adjust charging types and connections in real-time addresses the inefficiencies of traditional systems, resulting in faster charging times and lower operational costs. This advancement also enhances user experience by automating charging adjustments based on current needs and battery status, reducing manual intervention. Additionally, the flexible design supports grid stability and reliability by optimizing resource management, setting a new standard in EV charging technology.

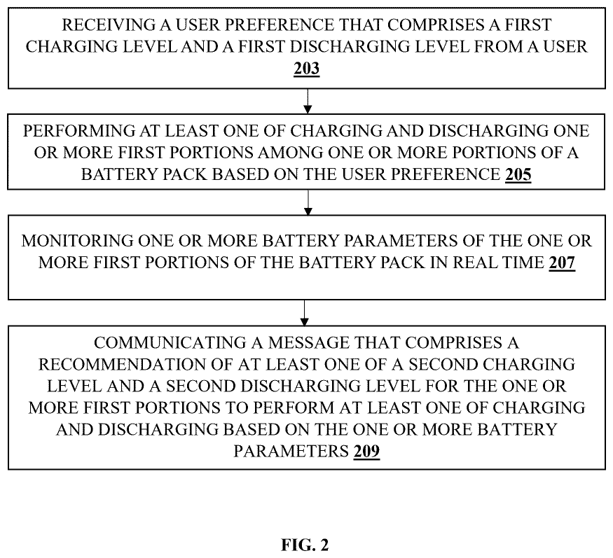

In one aspect, a method is described. As an example, FIG. 2 illustrates a method for recommending one or more charging and one or more discharging levels according to one or more embodiments. The method comprises the following technical steps: receiving a user preference that comprises a first charging level and a first discharging level from a user (at step 203); performing at least one of charging and discharging one or more first portions among one or more portions of a battery pack based on the user preference, wherein each of the one or more portions is configured to support one or more charging levels and one or more discharging levels (at step 205); monitoring one or more battery parameters of the one or more first portions of the battery pack in real time (at step 207); and communicating a message that comprises a recommendation of at least one of a second charging level and a second discharging level for the one or more first portions to perform at least one of charging and discharging based on the one or more battery parameters (at step 209).

In one embodiment, each portion of the one or more portions is connected electrically. In one embodiment, the each portion is connected with one or more contact points.

In one embodiment, the one or more contact points are electrically coupled at one or more positions of the vehicle. In one embodiment, the one or more positions are selected from the group consisting of front, rear, and left and right side of the vehicle.

In one embodiment, the one or more charging levels comprise at least one of the first charging level, the second charging level and a third charging level. In one embodiment, the first charging level is fast charging. In one embodiment, the second charging level is standard charging. In one embodiment, the third charging level is trickle charging.

In one embodiment, the one or more discharging levels comprise at least one of the first discharging level, the second discharging level and a third discharging level. In one embodiment, the first discharging level is high power discharging. In one embodiment, the second discharging level is standard discharging. In one embodiment, the third discharging level is low power discharging.

In one embodiment, the one or more battery parameters comprise at least one of temperature, voltage, current flow, state of charge (SOC), state of health (SOH), internal resistance, cycle count, capacity, power output, charge rate, discharge rate, energy density, Depth of Discharge (DoD), and C-rate.

In one embodiment, the method further comprises: assigning at least one of the second charging level and the second discharging level for the one or more first portions based on the user preference.

In one embodiment, the method further comprises: continuously monitoring the one or more battery parameters of the one or more first portions to determine if the one or more battery parameters exceed a threshold level. In one embodiment, the method further comprises: modifying one of the first charging level and the first discharging level assigned to the one or more first portions if the one or more battery parameters of the one or more first portions exceed the threshold level.

In one embodiment, the method further comprises: modifying one of the first charging level and the first discharging level assigned to the one or more first portions based on the user preference. In one embodiment, the method further comprises: performing at least one of charging and discharging the one or more first portions of the battery pack based on the second charging level and the second discharging level until the one or more battery parameters of the one or more first portions reach the threshold level.

In one embodiment, the method further comprises: reassigning the first charging level and the first discharging level to the one or more first portions if the one or more battery parameters of the one or more first portions fall below the threshold level. In one embodiment, the method further comprises: reassigning the first charging level and the first discharging level to the one or more first portions based on the user preference.

In one embodiment, the method further comprises: modifying the one or more charging levels assigned to the one or more contact points based on the user preference. In one embodiment, the method further comprises: modifying the one or more discharging levels assigned to the one or more contact points based on the user preference

In one embodiment, the method further comprises: receiving the user preference through an interactive display within the vehicle. In one embodiment, the method further comprises: receiving the user preference through a user device associated with the user. In one embodiment, the method further comprises: receiving the user preference from the user device through a network. In one embodiment, the network comprises a communication network selected from a group comprising wired networks, wireless networks, and a combination thereof. In one embodiment, the method further comprises: receiving the user preference through an interactive display on a wall unit.

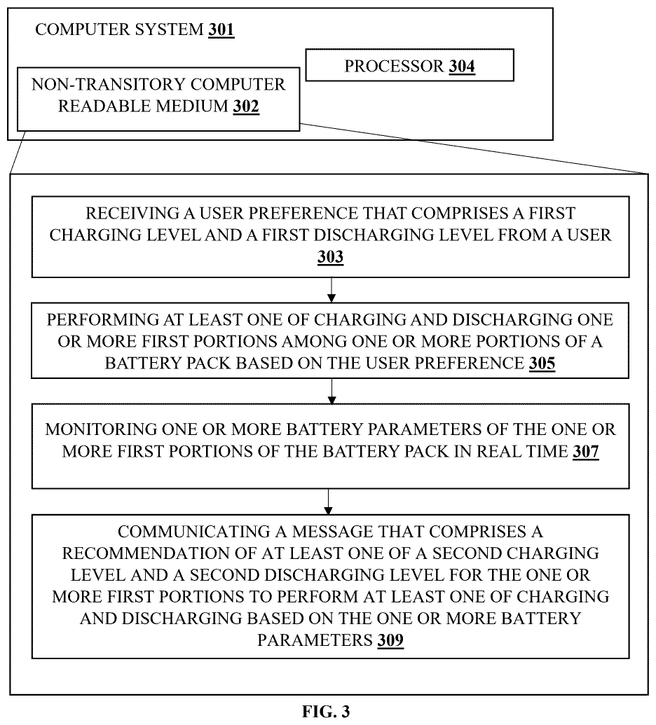

As an example, FIG. 3 illustrates a non-transitory computer readable storage medium 302 for recommending one or more charging and one or more discharging levels, according to one or more embodiments. According to an embodiment, disclosed is a computer system 301 comprising the non-transitory computer-readable medium 302 having stored thereon instructions executable by a processor 304 to perform operations comprising: receiving a user preference that comprises a first charging level and a first discharging level from a user (at step 303); performing at least one of charging and discharging one or more first portions among one or more portions of a battery pack based on the user preference, wherein each of the one or more portions is configured to support one or more charging levels and one or more discharging levels (at step 305); monitoring one or more battery parameters of the one or more first portions of the battery pack in real time (at step 307); and communicating a message that comprises a recommendation of at least one of a second charging level and a second discharging level for the one or more first portions to perform at least one of charging and discharging based on the one or more battery parameters (at step 309).

In one embodiment, each portion of the one or more portions is connected electrically. In one embodiment, the each portion is connected with one or more contact points.

In one embodiment, the one or more contact points are electrically coupled at one or more positions of the vehicle. In one embodiment, the one or more positions are selected from the group consisting of front, rear, and left and right side of the vehicle.

In one embodiment, the one or more charging levels comprise at least one of the first charging level, the second charging level and a third charging level. In one embodiment, the first charging level is fast charging. In one embodiment, the second charging level is standard charging. In one embodiment, the third charging level is trickle charging.

In one embodiment, the one or more discharging levels comprise at least one of the first discharging level, the second discharging level and a third discharging level. In one embodiment, the first discharging level is high power discharging. In one embodiment, the second discharging level is standard discharging. In one embodiment, the third discharging level is low power discharging.

In one embodiment, the one or more battery parameters comprise at least one of temperature, voltage, current flow, state of charge (SOC), state of health (SOH), internal resistance, cycle count, capacity, power output, charge rate, discharge rate, energy density, Depth of Discharge (DoD), and C-rate.

In one embodiment, the non-transitory computer readable storage medium further causes: assigning at least one of the second charging level and the second discharging level for the one or more first portions based on the user preference. In one embodiment, the non-transitory computer readable storage medium further causes: continuously monitoring the one or more battery parameters of the one or more first portions to determine if the one or more battery parameters exceed a threshold level.

In one embodiment, the non-transitory computer readable storage medium further causes: modifying one of the first charging level and the first discharging level assigned to the one or more first portions if the one or more battery parameters of the one or more first portions exceed the threshold level. In one embodiment, the non-transitory computer readable storage medium further causes: modifying one of the first charging level and the first discharging level assigned to the one or more first portions based on the user preference.

In one embodiment, the non-transitory computer readable storage medium further causes: performing at least one of charging and discharging the one or more first portions of the battery pack based on the second charging level and the second discharging level until the one or more battery parameters of the one or more first portions reach a threshold level. In one embodiment, the non-transitory computer readable storage medium further causes: reassigning the first charging level and the first discharging level to the one or more first portions if the one or more battery parameters of the one or more first portions fall below the threshold level. In one embodiment, the non-transitory computer readable storage medium further causes: reassigning the first charging level and the first discharging level to the one or more first portions based on the user preference

In one embodiment, the non-transitory computer readable storage medium further causes: modifying the one or more charging levels assigned to the one or more contact points based on the user preference. In one embodiment, the non-transitory computer readable storage medium further causes: modifying the one or more discharging levels assigned to the one or more contact points based on the user preference.

In one embodiment, the non-transitory computer readable storage medium further causes: receiving the user preference through an interactive display within the vehicle. In one embodiment, the non-transitory computer readable storage medium further causes: receiving the user preference through a user device associated with the user. In one embodiment, the non-transitory computer readable storage medium further causes: receiving the user preference from the user device through a network. In one embodiment, the network comprises a communication network selected from a group comprising wired networks, wireless networks, and a combination thereof.

In one embodiment, the non-transitory computer readable storage medium further causes: receiving the user preference through an interactive display on a wall unit.

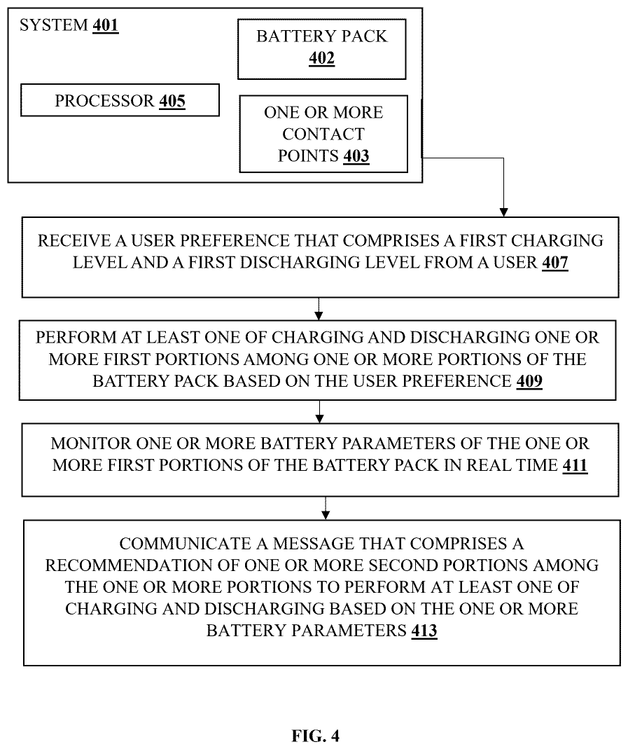

In an aspect, a system is described. As an example, FIG. 4 illustrates a system for recommending one or more portions according to one or more embodiments. The system 401 comprises: a battery pack 402 that comprises one or more portions, wherein each of the one or more portions is configured to support one or more charging levels and one or more discharging levels; one or more contact points 403 for connecting a charging cable to the battery pack 402, wherein each of the one or more contact points 403 are assigned to one of the one or more charging levels and the one or more discharging levels; a processor 405 communicatively coupled to the battery pack 402, wherein the processor 405 is operable to: receive a user preference that comprises a first charging level and a first discharging level from a user (at step 407); perform at least one of charging and discharging one or more first portions among the one or more portions of the battery pack 402 based on the user preference (at step 409); monitor one or more battery parameters of the one or more first portions of the battery pack 402 in real time (at step 411); and communicate a message that comprises a recommendation of one or more second portions among the one or more portions to perform at least one of charging and discharging based on the one or more battery parameters (at step 413).

In an embodiment, the processor 405 is operable to assign the one or more second portions among the one or more portions based on the user preference. In an embodiment, the processor 405 is operable to continuously monitor the one or more battery parameters of the one or more first portions to determine if the one or more battery parameters exceed a threshold level.

In an embodiment, the processor 405 is operable to modify one of the first charging level and the first discharging level assigned to the one or more first portions if the one or more battery parameters of the one or more first portions exceed the threshold level.

In an embodiment, the processor 405 is operable to perform at least one of charging and discharging the one or more second portions of the battery pack 402 based on one of the first charging level and the first discharging level until the one or more battery parameters of the one or more first portions fall below the threshold level.

In an embodiment, the processor 405 is operable to reassign the one or more first portions to perform one of charging or discharging based on the first charging level and the first discharging level if the one or more battery parameters of the one or more first portions are below the threshold level. In an embodiment, the processor 405 is operable to reassign the one or more first portions to perform one of charging or discharging based on the user preference.

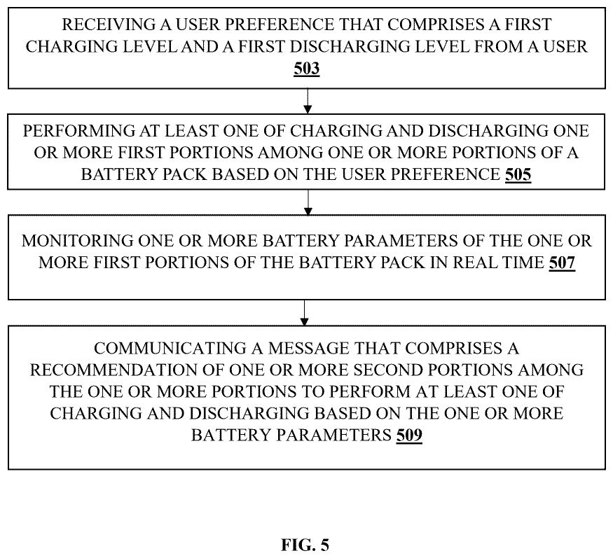

In one aspect, a method is described. As an example, FIG. 5 illustrates a method for recommending one or more portions according to one or more embodiments. The method comprises the following technical steps: receiving a user preference that comprises a first charging level and a first discharging level from a user (at step 503); performing at least one of charging and discharging one or more first portions among one or more portions of a battery pack based on the user preference, wherein each of the one or more portions is configured to support one or more charging levels and one or more discharging levels (at step 505); monitoring one or more battery parameters of the one or more first portions of the battery pack in real time (at step 507); and communicating a message to the user that comprises a recommendation of one or more second portions among the one or more portions to perform at least one of charging and discharging based on the one or more battery parameters (at step 509).

In one embodiment, the method further comprises: assigning the one or more second portions among the one or more portions based on the user preference.

In one embodiment, the method further comprises: continuously monitoring the one or more battery parameters of the one or more first portions to determine if the one or more battery parameters exceed a threshold level.

In one embodiment, the method further comprises: modifying one of the first charging level and the first discharging level assigned to the one or more first portions if the one or more battery parameters of the one or more first portions exceed the threshold level.

In one embodiment, the method further comprises: performing at least one of charging and discharging the one or more second portions of the battery pack based on one of the first charging level and the first discharging level until the one or more battery parameters of the one or more first portions fall below the threshold level. In one embodiment, the method further comprises: reassigning the one or more first portions to perform one of charging or discharging based on the first charging level and the first discharging level if the one or more battery parameters of the one or more first portions are below the threshold level. In one embodiment, the method further comprises: reassigning the one or more first portions to perform one of charging or discharging based on the user preference.

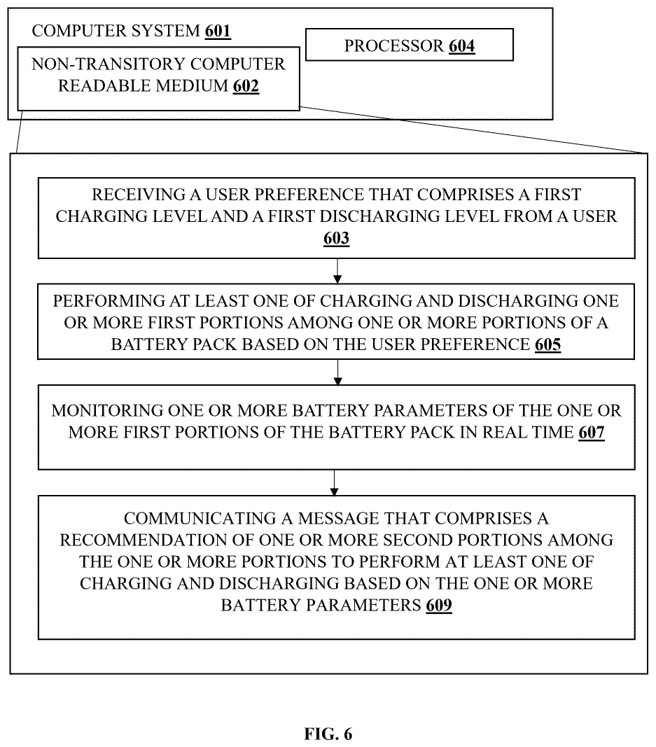

As an example, FIG. 6 illustrates a non-transitory computer readable storage medium 602 for recommending one or more portions according to one or more embodiments. According to an embodiment, disclosed is a computer system 601 comprising the non-transitory computer-readable medium 602 having stored thereon instructions executable by a processor 604 to perform operations comprising: receiving a user preference that comprises a first charging level and a first discharging level from a user (at step 603); performing at least one of charging and discharging one or more first portions among one or more portions of a battery pack based on the user preference, wherein each of the one or more portions is configured to support one or more charging levels and one or more discharging levels (at step 605); monitoring one or more battery parameters of the one or more first portions of the battery pack in real time (at step 607); and communicating a message to the user that comprises a recommendation of one or more second portions among the one or more portions to perform at least one of charging and discharging based on the one or more battery parameters (at step 609).

In one embodiment, the non-transitory computer readable storage medium further causes: assigning the one or more second portions among the one or more portions based on the user preference.

In one embodiment, the non-transitory computer readable storage medium further causes: continuously monitoring the one or more battery parameters of the one or more first portions during charging and discharging to determine if the one or more battery parameters exceed a threshold level.

In one embodiment, the non-transitory computer readable storage medium further causes: modifying one of the first charging level and the first discharging level assigned to the one or more first portions if the one or more battery parameters of the one or more first portions exceed the threshold level.

In one embodiment, the non-transitory computer readable storage medium further causes: performing at least one of charging and discharging the one or more second portions of the battery pack based on one of the first charging level and the first discharging level until the one or more battery parameters of the one or more first portions fall below the threshold level. In one embodiment, the non-transitory computer readable storage medium further causes: reassigning the one or more first portions to perform one of charging or discharging based on the first charging level and the first discharging level if the one or more battery parameters of the one or more first portions are below the threshold level. In one embodiment, the non-transitory computer readable storage medium further causes: reassigning the one or more first portions to perform one of charging or discharging based on the user preference.

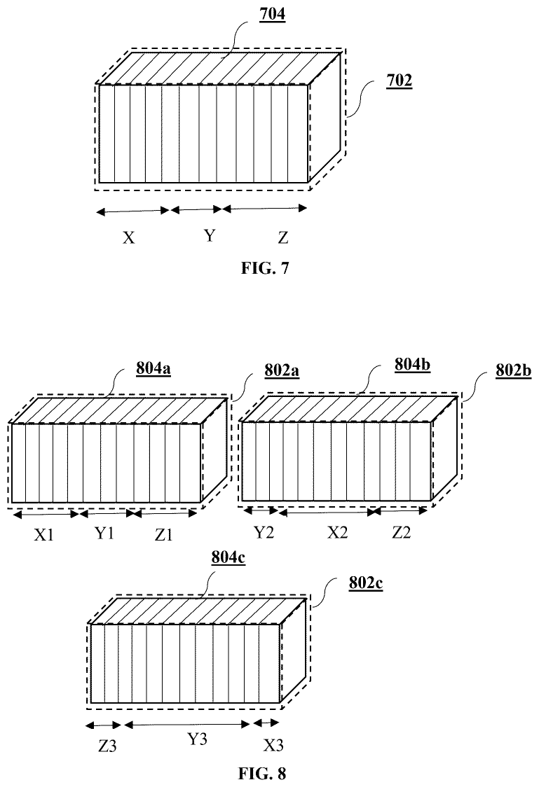

As an example, FIG. 7 illustrates a battery pack 702 comprising an individual battery, according to one or more embodiments. The battery pack 702 may be the battery within the charging station. In one embodiment, the battery pack 702 is within a vehicle. The battery pack 702 within the charging station is stationary and large enough to supply power to charge multiple vehicles simultaneously. The battery within the charging station is huge when compared to the battery within the electric vehicles. The battery pack 702 herein comprises an individual battery. The battery comprises a plurality of cells 704. The battery pack comprises a first portion X, a second portion Y, and a third portion Z. The first portion X may comprise a first plurality of cells among the plurality of cells of the battery. The second portion Y may comprise a second plurality of cells among the plurality of cells of the battery. The third portion Z may comprise a third plurality of cells among the plurality of cells of the battery.

The first portion X, the second portion Y, and the third portion Z may be categorized based on the state-of-health information at the respective portions. The first portion X may comprise a first state-of-health. The second portion Y may comprise a second state-of-health. The third portion Z may comprise a third state-of-health. In an embodiment, the first portion may refer to a portion of the battery having degraded cells. The second portion may refer to a portion of the battery having healthy cells. The third portion may refer to a portion of the battery having moderate degraded cells. The processor may be configured to detect the state-of-charge of the battery pack 702 having at least one of healthy cells, degraded cells, and moderate degraded cells.

As an example, FIG. 8 illustrates a battery pack comprising a plurality of batteries, according to one or more embodiments. The battery pack herein comprises a first battery 802a, a second battery 802b, and a third battery 802c. The first battery 802a may comprise a plurality of first cells 804a. The second battery 802b may comprise a plurality of second cells 804b. The third battery 802c may comprise a plurality of third cells 804c. Each battery of the battery pack is connected electrically to get charged. The charging station charges each battery of the battery pack. The charging station may charge each battery of the battery pack through at least one of randomly, serially, and parallelly.

The charging station may charge at least one of a first portion X, a second portion Y, and a third portion Z of the battery pack. The first portion X of the battery pack refers to degraded cells from one or more batteries of the battery pack (X=X1+X2+X3). The second portion Y of the battery pack refers to healthy cells from one or more batteries of the battery pack (Y=Y1+Y2+Y3). The third portion Z of the battery pack refers to moderate degraded cells from one or more batteries of the battery pack (Z=Z1+Z2+Z3). Healthy cells may be contiguous or non-contiguously located within the same battery. Similarly, degraded, and moderate degraded cells may be contiguous or non-contiguously located within the same battery. In one embodiment, the charging station may charge in combination of degraded cells, healthy cells, and moderate degraded cells from the one or more batteries.

The charging station is configured to map the battery pack based on the state-of-health information. In an embodiment, the charging station maps at least one of the degraded cells, the healthy cells, and the moderate degraded cells of the battery pack. The charging station, upon performing mapping the battery pack, computes the state-of-charge considering the state-of-health information.

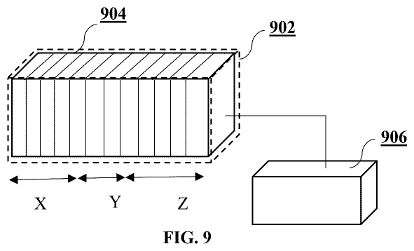

As an example, FIG. 9 schematically shows a battery pack comprising a battery 902 and a battery management system 906, according to one or more embodiments. The battery 902 in turn comprises a plurality of cells 904. The battery management system 906 may include a microprocessor, microcontroller, programmable digital signal processor, or another programmable device. The battery management system 906 may also or alternatively comprise an application specific integrated circuit, a programmable gate array or programmable array logic, a programmable logic device or a digital signal processor. Where the battery management system 906 comprises a programmable device such as the microprocessor, microcontroller or programmable digital signal processor mentioned above, the processor may also comprise computer executable code which controls the operation of the programmable device. In an embodiment, the battery management system 906 resides within an electric vehicle. The battery management system 906 determines the state-of-charge (SoC) of the battery pack and communicates to the charging station via a vehicle computer system.

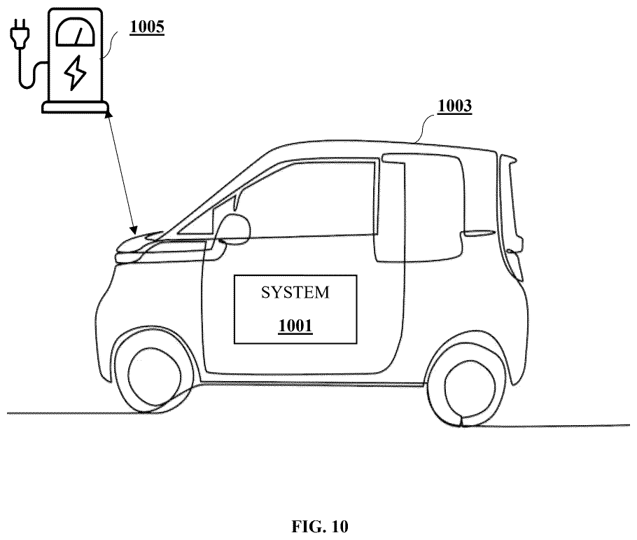

As an example, FIG. 10 illustrates a system 1001 integrated into a vehicle 1003 according to one or more embodiments. The system 1001 comprises a battery pack that comprises one or more portions. Each of the one or more portions is configured to support one or more charging levels and one or more discharging levels. The system 1001 comprises one or more contact points for connecting a charging cable to the battery pack. The system 1001 assigns the one or more charging levels and the one or more discharging levels to each of the one or more contact points. The system 1001 may assign the one or more charging levels and the one or more discharging levels to each of the one or more contact points based on the user preference. In one embodiment, the one or more contact points are electrically coupled at one or more positions of the vehicle 1003. The one or more positions are selected from the group consisting of front, rear, and left and right side of the vehicle 1003. The system 1001 receives a user preference that comprises a first charging level and a first discharging level from a user. The system 1001 performs at least one of charging and discharging one or more first portions among the one or more portions of the battery pack based on the user preference. In one embodiment, the system 1001 performs at least one of charging and discharging using a charging system. The charging system comprises one or more charging stations 1005 that can provide different levels of charging, such as fast charging, standard charging, and trickle charging. The charging system includes discharge contact points that manage energy release from the battery pack of the vehicle 1003. The system 1001 monitors one or more battery parameters of the one or more first portions of the battery pack in real time. In an embodiment, the one or more battery parameters comprise at least one of temperature, voltage, current flow, state of charge (SOC), state of health (SOH), internal resistance, cycle count, capacity, power output, charge rate, discharge rate, energy density, Depth of Discharge (DoD), and C-rate. In an embodiment, the one or more battery parameters comprise power density, charge acceptance, round-trip efficiency, self-discharge rate, maximum charge/discharge current, thermal stability, thermal runaway threshold, voltage sag, charge cut-off voltage, discharge cut-off voltage, impedance, calendar life, float voltage, and Peukert's number. The system 1001 communicates a message to the user that comprises a recommendation of at least one of a second charging level and a second discharging level for the one or more first portions or recommendation of one or more second portions among the one or more portions to perform at least one of charging and discharging based on the one or more battery parameters.

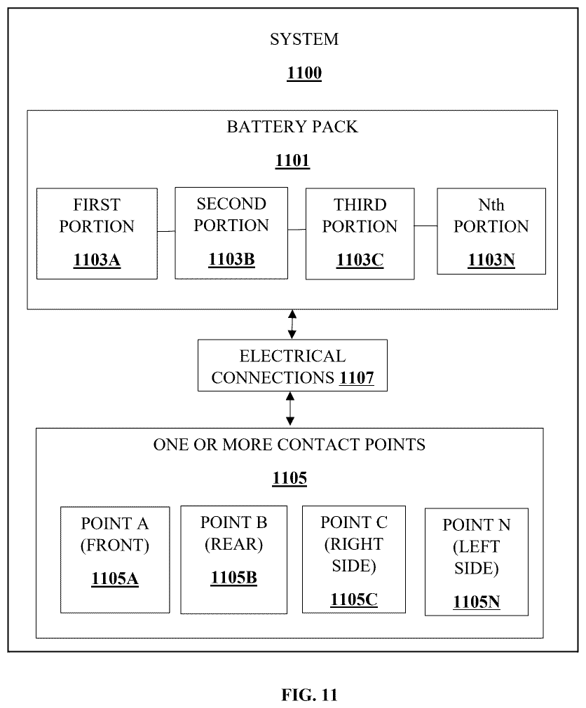

As an example, FIG. 11 illustrates a schematic view of a system 1100 that comprises a battery pack 1101 and one or more contact points 1105A-N according to one or more embodiments. The battery pack 1101 is divided into one or more portions 1103A-N, each capable of supporting different charging and discharging levels. Each portion is electrically connected to facilitate efficient energy management through electrical connections 1107. For example, a first portion 1103A is configured for fast charging and high-power discharging, a second portion 1103B is configured for standard charging and standard discharging, a third portion 1103C is configured for trickle charging and low power discharging, and a N^{th} Portion 1103N represents additional portions with various configurations. Each portion is connected electrically within the battery pack 1101 to enable the transfer of energy and data, ensuring that the energy management system can control and monitor each portion individually or collectively. The system 1100 comprises the one or more contact points 1105A-N for connecting a charging cable, each contact point assigned to specific charging and discharging levels. For example, a point A 1105A is located at the front of the vehicle for fast charging and high-power discharging, a point B 1105B is located at the rear of the vehicle for standard charging and standard discharging, a point C 1105C is located on the right side of the vehicle for trickle charging and low power discharging and a point N 1105N is located on the left side of the vehicle for additional configurations. In one embodiment, if the user selects the point A 1105A as fast charge, then the energy is routed to the fast-charging portion (e.g., the first portion 1103A) of the battery pack. In one embodiment, the one or more contact points 1105A-N at both the front and rear for fast charging/discharging, as the same contact points being used for standard charging/discharging. The system 1100 can dynamically assign each contact point based on user preferences. For example, two front connections can be set for standard charging, but they can be reconfigured for fast charging based on the user preferences. The system 1100 has the capability to direct energy either to a specific portion of the battery pack 1101 or to the entire battery, depending on the requirements of the system. The system 1100 can adaptively adjust the configuration based on health of the battery pack 1101 by monitoring one or more battery parameters of each portion. For example, if a contact point (e.g., the point A 1105) is selected for fast charging (e.g., the first portion 1103A) but the first portion 1103A exceeds a threshold level (e.g., the temperature of the first portion 1103A exceeds the threshold level), the system 1100 can reduce the charge rate to standard or trickle charging until the temperature decreases or the first portion 1103A is fully charged. Additionally, the system 1100 reroutes the energy to a different battery portion if the first portion 1103A is fully charged or overheating.

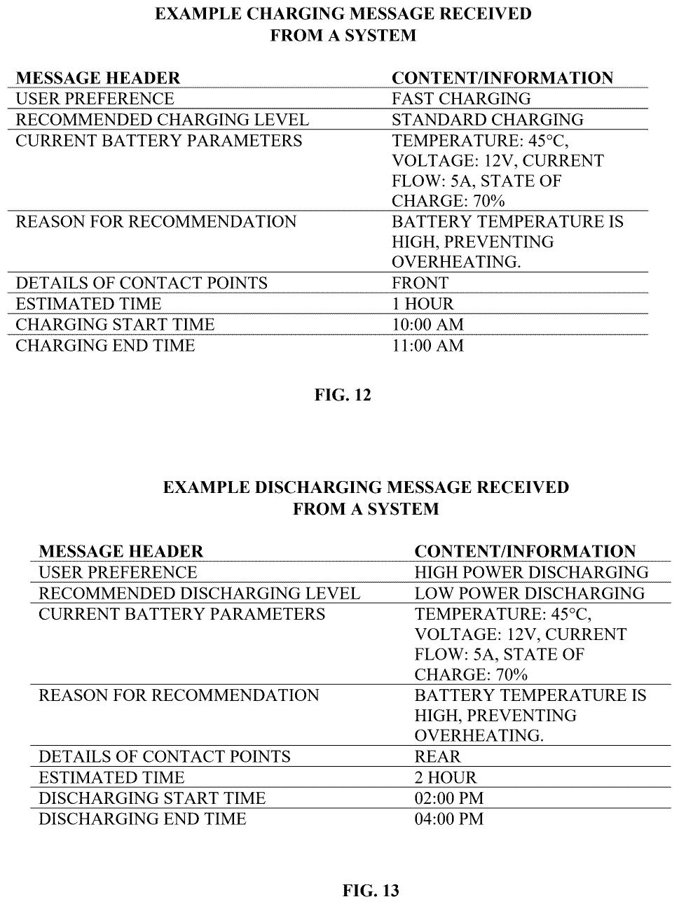

As an example, FIG. 12 illustrates a charging message received from a system, according to one or more embodiments. The charging message comprises fields such as a user preference, recommended charging level, current battery parameters, reason for recommendation, details of contact points, estimated time, charging start and end time. The user preference denotes a charging level selected by the user, such as fast charging, standard charging, or trickle charging. The user preference depicts that the user has selected fast charging. The recommended charging level reflects the suggested level of charging that aligns with the user's choice while the system considers one or more battery parameters of the one or more portions of the battery pack in real time. The current battery parameters provide information about the one or more battery parameters of the one or more first portions of the battery pack in real time. This includes details such as temperature, voltage, current flow, and state of charge. The reason for the system recommendation to the user and the charger explains why a particular charging level is suggested. This explanation recorded in the system is based on the analysis of the one or more battery parameters and ensures that the selected charging level, e.g., standard charging, is appropriate for the current conditions, such as recommending standard charging to prevent overheating if the battery is nearly full. The details of contact points are recorded and comprise information about physical connection points used for charging. For example, contact points may be located in various positions of the vehicle, such as the front and rear, to facilitate different types of charging. In an embodiment, one specific contact point could be designated for fast charging, while others might be used for standard or trickle charging. The estimated time comprises information about the time for completing the charging process based on the system's recommended levels. The charging start and end time specifies the anticipated times for initiating and completing the charging process based on the system's recommended levels, e.g., standard charging.

As an example, FIG. 13 illustrates a discharging message received from a system, according to one or more embodiments. The discharging message comprises fields such as a user preference, recommended discharging level, current battery parameters, reason for recommendation, details of contact points, estimated time, discharging start and end time. The user preference denotes a discharging level selected by the user, e.g., high power discharging. The recommended discharging level reflects the suggested level of discharging that aligns with the user's choice while considering one or more battery parameters of the one or more portions of the battery pack in real time. The current battery parameters provide information about the one or more battery parameters of the one or more first portions of the battery pack in real time. This includes details such as temperature, voltage, current flow, and state of charge. The reason for recommendation explains why a particular discharging level is suggested. This explanation is based on the analysis of the one or more battery parameters and ensures that the selected discharging level, e.g., standard discharging, is appropriate for the current conditions. The details of contact points comprise information about physical connection points used for discharging. For example, contact points may be located in various positions of the vehicle, such as the front and rear, to facilitate different types of discharging. For example, the contact points may be positioned at the front and rear of the vehicle, with specific contact points designated for high power or standard discharging. The estimated time comprises information about the time for completing the discharging process based on the recommended levels, (e.g., 2 hours). The discharging start and end time specifies the expected start and end times for the discharging process at the recommended levels, (e.g., 02:00 PM-04:00 PM).

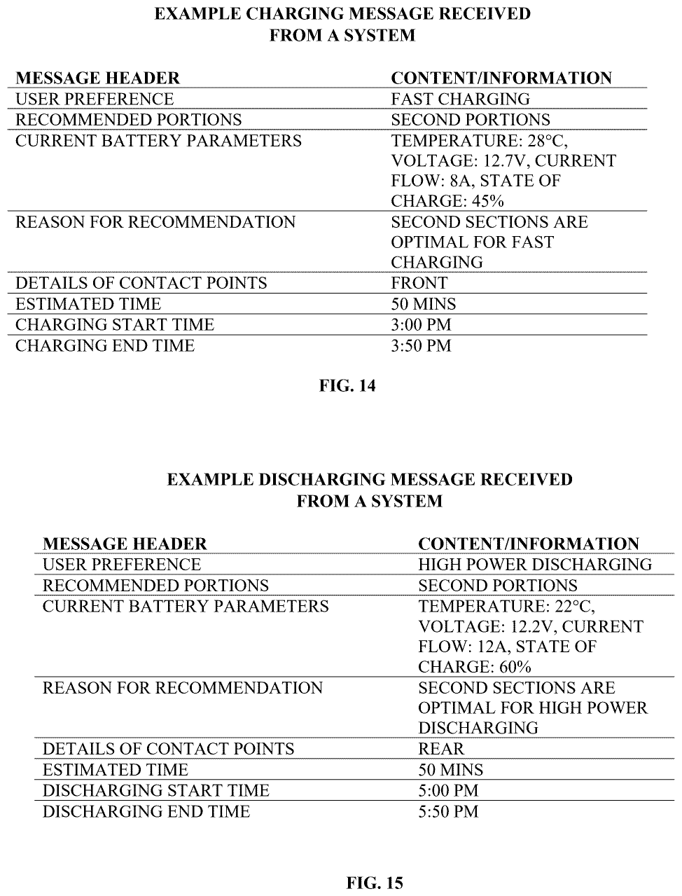

As an example, FIG. 14 illustrates a charging message received from a system, according to one or more embodiments. The charging message comprises fields such as a user preference, recommended portions, current battery parameters, reason for recommendation, details of contact points, estimated time, charging start and end time. The user preference specifies a charging level selected by the user, for example, fast charging. The recommended portions field identifies which portions of the battery pack are recommended by the system for charging based on the one or more battery parameters of the one or more first portions among the one or more portions; for example, the system recommends one or more second portions for fast charging instead of the one or more first portions. The current battery parameters provide real-time information on the battery's state, including temperature, voltage, current flow, and state of charge, etc. of the one or more first portions. The reason for recommendation explains why the particular portions, (e.g., one or more second portions) are recommended for charging, such as their optimal performance for fast charging while remaining within safe temperature limits. The details of contact points indicate where the charging connections should be made, e.g., “charging should be done through connections at the front of the vehicle”. The estimated time provides an approximation of how long it will take to reach the desired charge level, here noted as “50 minutes to reach 80% charge”. The charging start and end time provides the expected time frame for the charging process, for example, “3:00 PM-3:50 PM”.

As an example, FIG. 15 illustrates a discharging message received from a system, according to one or more embodiments. The discharging message comprises fields such as a user preference, recommended portions, current battery parameters, reason for recommendation, details of contact points, estimated time, discharging start and end time. The user preference specifies a discharging level selected by the user, for example, high power discharging. The recommended portions field identifies which portions of the battery pack are recommended by the system for discharging based on the one or more battery parameters of the one or more first portions among the one or more portions; for example, the system recommends one or more second portions for high power discharging instead of the one or more first portions. The current battery parameters provide real-time information on the battery's state, including temperature, voltage, current flow, and state of charge, etc. of the one or more first portions. The reason for recommendation explains why the particular portions, (e.g., one or more second portions) are recommended for discharging. The details of contact points indicate where the discharging connections should be made, e.g., “discharging should be done through connections at the rear of the vehicle”. The estimated time provides information about the time for completing the discharging process based on the recommended portions. The discharging start and end time provides the expected time frame for the discharging process, for example, “5:00 PM-5:50 PM”.

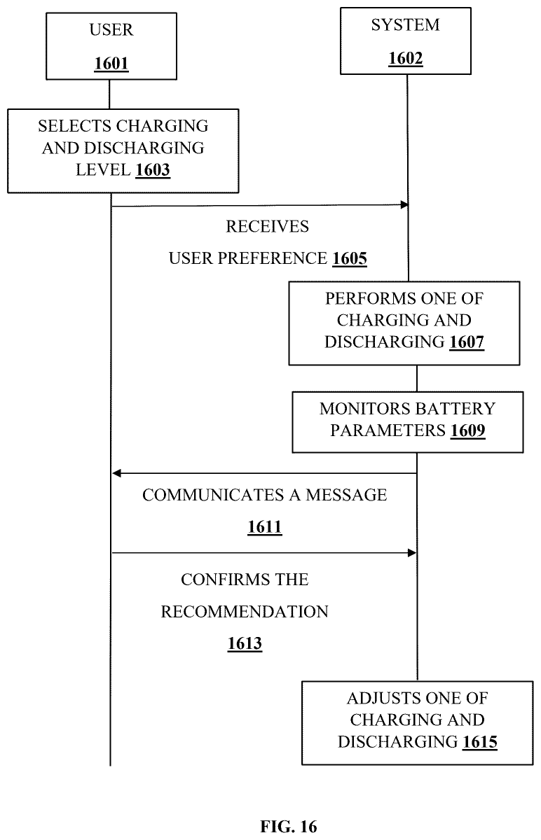

As an example, FIG. 16 illustrates a communication flow between a system and a user according to one or more embodiments. At step 1603, the user 1601 selects one of a first charging level (e.g., fast charging) and a first discharging level (e.g., high power discharging). The user 1601 may select these charging and discharging levels via the vehicle's interface. The user 1601 may select these charging and discharging levels via a user device associated with the user 1601. The user 1601 may select these charging and discharging levels via an interactive display on a wall unit. The selected preferences are communicated to the system 1602. At step 1605, the system 1602 receives the user preference comprising the first charging level and the first discharging level from the user 1601. At step 1607, the system 1602 performs at least one of charging and discharging one or more first portions among the one or more portions of the battery pack based on the user preference. At step 1609, the system 1602 monitors one or more battery parameters of the one or more first portions of the battery pack in real time. At step 1611, the system 1602 communicates a message to the user that comprises a recommendation of at least one of a second charging level and a second discharging level for the one or more first portions or a recommendation of one or more second portions among the one or more portions to perform at least one of charging and discharging based on the one or more battery parameters. The message comprises fields such as the user preference, recommended charging level or discharging level, current battery parameters, reason for recommendation, details of contact points, estimated time, charging start and end time. The message may comprise fields such as the user preference, recommended portions, current battery parameters, reason for recommendation, details of contact points, estimated time, charging start and end time. The user 1601 receives the notification and recommendation on the vehicle's interface. At step 1613, the user 1601 can confirm the system's recommendation or modify their preferences. Based on the user's response, the system 1602 adjusts the charging/discharging operations, accordingly, possibly selecting new portions or adjusting the levels at step 1615.

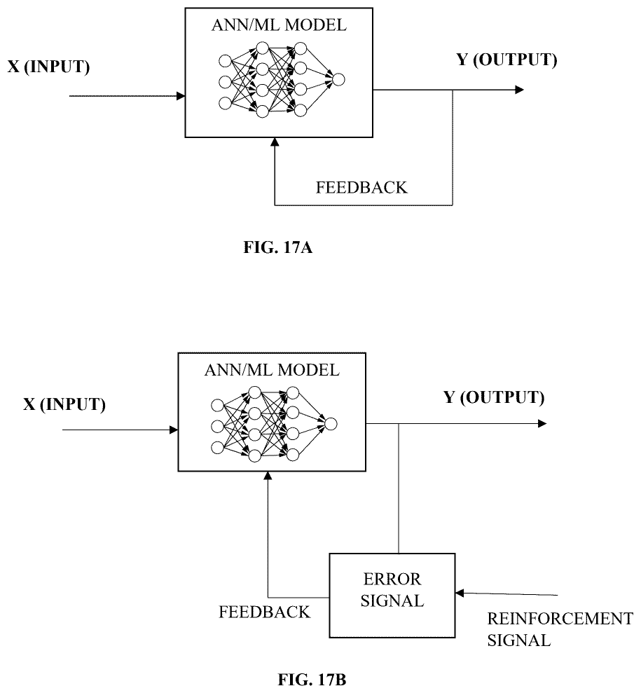

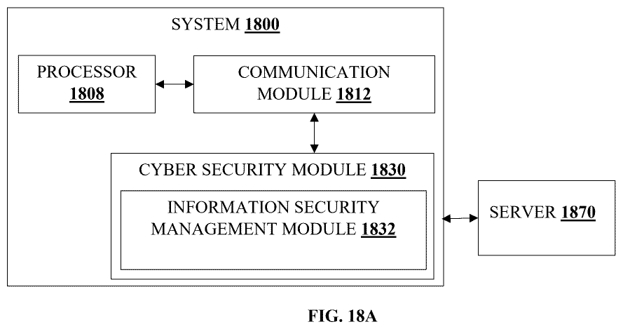

As an example, FIG. 17A shows a structure of the neural network/machine learning model with a feedback loop. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may communicate a command to the battery management system to perform one of charging and discharging.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN). Neural Networks can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, and image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback (error signal). The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine learning, backpropagation and feedback loops are used to train an AI model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the Artificial Intelligence/Machine Learning (AI/ML) model is trained well, with large sets of labelled data and concepts, after a while, the models'performance may decline while adding new, unlabelled input due to many reasons which include, but not limited to, concept drift, recall precision degradation due to drifting away from true positives, and data drift over time. A feedback loop in the model keeps the AI results accurate and ensures that the model maintains its performance and improvement, even when new unlabelled data is assimilated. A feedback loop refers to the process by which an AI model's predicted output is reused to train new versions of the model.

Initially, when the AI/ML model is trained, a few labelled samples comprising both positive and negative examples of the concepts (for e.g., recommending one or more charging levels, one or more discharging levels, and one or more portions, etc.) are used that are meant for the model to learn. Afterward, the model is tested using unlabelled data. By using, for example, deep learning and neural networks, the model can then make predictions on whether the desired concept/s (for e.g., recommending one or more charging levels, one or more discharging levels, and one or more portions, etc.) are in unlabelled images. Each image is given a probability score where higher scores represent a higher level of confidence in the models'predictions. Where a model gives an image a high probability score, it is auto labelled with the predicted concept. However, in the cases where the model returns a low probability score, this input may be sent to a controller (may be a human moderator) which verifies and, as necessary, corrects the result. The human moderator may be used only in exception cases. The feedback loop feeds labelled data, auto-labelled or controller-verified, back to the model dynamically and is used as training data so that the system can improve its predictions in real-time and dynamically.

As an example, FIG. 17B shows a structure of the neural network/machine learning model with reinforcement learning. The network receives feedback from authorized networked environments. Though the system is similar to supervised learning, the feedback obtained in this case is evaluative not instructive, which means there is no teacher as in supervised learning. After receiving the feedback, the network performs adjustments of the weights to get better predictions in the future. Machine learning techniques, like deep learning, allow models to take labelled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

In an embodiment, icons on a graphical user interface (GUI) or display of the infotainment system of a computer system are re-arranged based on a priority score of the content of the message. The processor tracks the messages that need to be displayed at a given time and generates a priority score, wherein the priority score is determined based on the action that needs to be taken by the user, the time available before the user input is needed, content of the message to be displayed, criticality of the user's input/action that needs to be taken, the sequence of the message or messages that need to be displayed and executed, and the safety of the overall scenario. For example, in case of a health emergency, the messages in queue for displaying could be an emergency signal, type of emergency, intimation that an alert is provided to the nearby vehicles, instructing a path for the driver to pull over, calling the emergency services, etc. In all these messages that need a driver's attention, a priority score is provided based on the actions that need to be taken by the user, the time available for the user to receive the displayed message and react with an action, the content of the message, criticality of the user's input/action, sequence of the messages that need to be executed, and safety of the overall scenario. Considering the above example, the message that intimates the user/driver that an alert has been provided to nearby vehicles may be of lower priority as compared to instructing the path for the driver to pull over. Therefore, the pull over directions for the path message takes priority and takes such a place on the display (example, center of the display) which can grab the users'attention immediately. The priority of the messages is evaluated dynamically as the situation is evolving and thus the display icons, positions, and sizes of the text or icon on the display are changed in real-time and dynamically. In an embodiment, more than one message is displayed and highlighted as per the situation and the user's actions. Further, while pulling over, if an unsafe scenario is found, for example, a car is changing lanes which may obstruct the user's vehicle, the message dynamically changes and warns the driver about the developing scenario. In another scenario of a vehicle with charge less than threshold charge level, the processor dynamically reassigns the priority score and depicts nearby charging station and navigates the route to the charging station onto a display in the dashboard.

In an embodiment, the system further comprises a cyber security module wherein the cyber security module comprises an information security management module providing isolation between the communication module and servers.

In an embodiment, the information security management module is operable to, receive data from the communication module, exchange a security key at a start of the communication between the communication module and the server, receive the security key from the server, authenticate an identity of the server by verifying the security key, analyze the security key for a potential cyber security threat, negotiate an encryption key between the communication module and the server, encrypt the data; and transmit the encrypted data to the server when no cyber security threat is detected.

In an embodiment, the information security management module is operable to exchange a security key at a start of the communication between the communication module and the server, receive the security key from the server, authenticate an identity of the server by verifying the security key, analyze the security key for a potential cyber security threat, negotiate an encryption key between the system and the server, receive encrypted data from the server, decrypt the encrypted data, perform an integrity check of the decrypted data and transmit the decrypted data to the communication module when no cyber security threat is detected.

In an embodiment, the system may comprise a cyber security module.

In one aspect, a secure communication management (SCM) computer device for providing secure data connections is provided. The SCM computer device includes a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system.

According to an embodiment, secure authentication for data transmissions comprises, provisioning a hardware-based security engine (HSE) located in the information security management module, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

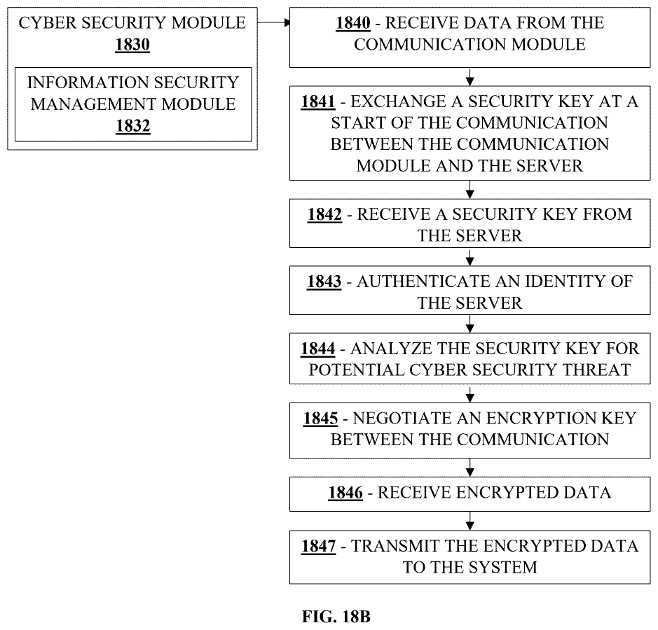

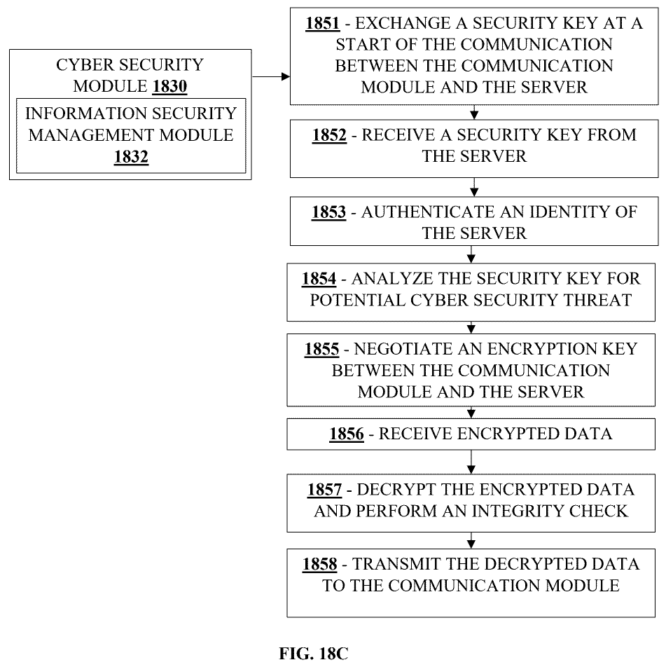

In an embodiment, FIG. 18A shows the block diagram of the cyber security module. The communication of data between the system 1800 and the server 1870, through the processor 1808, through the communication module 1812, is first verified by the information security management module 1832 before being transmitted from the system to the server or from the server to the system. The information security management module is operable to analyze the data for potential cyber security threats, to encrypt the data when no cyber security threat is detected, and to transmit the data encrypted to the system or the server.

In an embodiment, the cyber security module further comprises an information security management module providing isolation between the system and the server. FIG. 18B shows the flowchart of securing the data through the cyber security module 1830. At step 1840, the information security management module 1832 is operable to receive data from the communication module. At step 1841, the information security management module exchanges a security key at a start of the communication between the communication module and the server. At step 1842, the information security management module receives a security key from the server. At step 1843, the information security management module authenticates an identity of the server by verifying the security key. At step 1844, the information security management module analyzes the security key for potential cyber security threats. At step 1845, the information security management module negotiates an encryption key between the communication module and the server. At step 1846, the information security management module receives the encrypted data. At step 1847, the information security management module transmits the encrypted data to the server when no cyber security threat is detected.

In an embodiment, FIG. 18C shows the flowchart of securing the data through the cyber security module 1830. At step 1851, the information security management module 1832 is operable to: exchange a security key at a start of the communication between the communication module and the server. At step 1852, the information security management module receives a security key from the server. At step 1853, the information security management module authenticates an identity of the server by verifying the security key. At step 1854, the information security management module analyzes the security key for potential cyber security threats. At step 1855, the information security management module negotiates an encryption key between the communication module and the server. At step 1856, the information security management module receives encrypted data. At step 1857, the information security management module decrypts the encrypted data, and performs an integrity check of the decrypted data. At step 1858, the information security management module transmits the decrypted data to the communication module when no cyber security threat is detected.

In an embodiment, the integrity check is a hash-signature verification using a Secure Hash Algorithm 256 (SHA256) or a similar method.

In an embodiment, the information security management module is configured to perform asynchronous authentication and validation of the communication between the communication module and the server.

In an embodiment, the information security management module is configured to raise an alarm if a cyber security threat is detected. In an embodiment, the information security management module is configured to discard the encrypted data received if the integrity check of the encrypted data fails.

In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 18A, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature.

In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine.

In an embodiment, both communication parties need to authenticate their own identities through a pair of asymmetric keys, and a task in charge of communication with the information security management module of the system is identified by a unique pair of asymmetric keys.

In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising”as “comprising”is interpreted when employed as a transitional word in a claim.

Other specific forms may embody the present invention without departing from its spirit or characteristics. The described embodiments are in all respects illustrative and not restrictive. Therefore, the appended claims rather than the description herein indicate the scope of the invention. All variations which come within the meaning and range of equivalency of the claims are within their scope.

1-109. (canceled)

110. A system comprising:
a battery pack that comprises one or more portions, wherein each of the one or more portions is configured to support one or more charging levels and one or more discharging levels;
one or more contact points for connecting a charging cable to the battery pack, wherein each of the one or more contact points are assigned to one of the one or more charging levels and the one or more discharging levels; and
a processor communicatively coupled to the battery pack, wherein the processor is operable to:
receive a user preference that comprises a first charging level and a first discharging level from a user;
perform at least one of charging and discharging one or more first portions among the one or more portions of the battery pack based on the user preference;
monitor one or more battery parameters of the one or more first portions of the battery pack in real time; and
communicate a message that comprises a recommendation of at least one of a second charging level and a second discharging level for the one or more first portions to perform at least one of charging and discharging based on the one or more battery parameters.

111. The system of claim 110, wherein each portion of the one or more portions is connected electrically.

112. The system of claim 111, wherein the each portion is connected with the one or more contact points.

113. The system of claim 110, wherein the system is integrated into a vehicle.

114. The system of claim 113, wherein the one or more contact points are electrically coupled at one or more positions selected from the group consisting of front, rear, and left and right side of the vehicle.

115. The system of claim 110, wherein the one or more charging levels comprise at least one of the first charging level, the second charging level and a third charging level.

116. The system of claim 115, wherein the first charging level is fast charging, the second charging level is standard charging, and the third charging level is trickle charging.

117. The system of claim 110, wherein the one or more discharging levels comprise at least one of the first discharging level, the second discharging level and a third discharging level.

118. The system of claim 117, wherein the first discharging level is high power discharging, the second discharging level is standard discharging, and the third discharging level is low power discharging.

119. The system of claim 110, wherein the one or more battery parameters comprise at least one of temperature, voltage, current flow, state of charge (SOC), state of health (SOH), internal resistance, cycle count, capacity, power output, charge rate, discharge rate, energy density, Depth of Discharge (DoD), and C-rate.

120. The system of claim 110, wherein the processor is operable to assign at least one of the second charging level and the second discharging level for the one or more first portions based on the user preference.

121. The system of claim 110, wherein the processor is operable to modify the one or more charging levels and the one or more discharging levels assigned to the one or more contact points based on the user preference.

122. The system of claim 110, wherein the processor is operable to modify the one or more charging levels and the one or more discharging levels assigned to the one or more contact points based a threshold level of the one or more battery parameters corresponding to the one or more portions during charging and discharging the one or more portions.

123. A method comprising:
receiving a user preference that comprises a first charging level and a first discharging level from a user;
performing at least one of charging and discharging one or more first portions among one or more portions of a battery pack based on the user preference, wherein each of the one or more portions is configured to support one or more charging levels and one or more discharging levels;
monitoring one or more battery parameters of the one or more first portions of the battery pack in real time; and
communicating a message that comprises a recommendation of at least one of a second charging level and a second discharging level for the one or more first portions to perform at least one of charging and discharging based on the one or more battery parameters.

124. The method of claim 123, further comprising: continuously monitoring the one or more battery parameters of the one or more first portions to determine if the one or more battery parameters exceed a threshold level.

125. The method of claim 124, further comprising: modifying one of the first charging level and the first discharging level assigned to the one or more first portions if the one or more battery parameters of the one or more first portions exceed the threshold level.

126. The method of claim 124, further comprising: performing at least one of charging and discharging the one or more first portions of the battery pack based on the second charging level and the second discharging level until the one or more battery parameters of the one or more first portions reach the threshold level.

127. A non-transitory computer readable storage medium comprising a sequence of instructions, which when executed by a processor causes:
receiving a user preference that comprises a first charging level and a first discharging level from a user;
performing at least one of charging and discharging one or more first portions among one or more portions of a battery pack based on the user preference, wherein each of the one or more portions is configured to support one or more charging levels and one or more discharging levels;
monitoring one or more battery parameters of the one or more first portions of the battery pack in real time; and
communicating a message that comprises a recommendation of at least one of a second charging level and a second discharging level for the one or more first portions to perform at least one of charging and discharging based on the one or more battery parameters.

128. The non-transitory computer readable storage medium of claim 127, further comprising: reassigning the first charging level and the first discharging level to the one or more first portions if the one or more battery parameters of the one or more first portions fall below a threshold level.

129. The non-transitory computer readable storage medium of claim 127, further comprising: reassigning the first charging level and the first discharging level to the one or more first portions based on the user preference.
